(19) United States
(12) Patent Application Publication
(10) Pub. No.: US 2012/0128919 A1
(43) Pub. Date: May 24, 2012

(54) PART COMPRISING AN INSERT AND A PLASTIC SHEATHING AND METHOD FOR THE PRODUCTION THEREOF

(75) Inventors: Rebekka Von Benten, Ludwigshafen (DE); Alireza Talebloo, Mainz (DE); Harald Kröger, Bohl-Iggelheim (DE); Peter Eibeck, Speyer (DE); Rolf Minkwitz, Mannheim (DE)

(73) Assignee: BASF SE, Ludwigshafen (DE)

(21) Appl. No.: 13/386,108

(22) PCT Filed: Jul. 13, 2010
(86) PCT No.: PCT/EP2010/060068

§ 371 Date: Jan. 20, 2012

(30) Foreign Application Priority Data
Jul. 23, 2009 (EP) 09166252.8

(51) Int. Cl. B32B 3/02; B29C 45/16

(52) U.S. Cl. 428/68; 264/250

(57) ABSTRACT

The invention relates to a component comprising an insert part and plastics jacketing composed of at least two plastics components, where the insert part is enclosed by a first plastics component A and there is a second plastics component B enclosing the first plastics component A. The first plastics component A is composed of:
A1: from 10 to 100% by weight of at least one thermoplastic styrene (co)polymer and
A2: from 0 to 90% by weight of at least one thermoplastic (co)polyester,
   in each case based on the polymer content of the first plastics component A,
   and the second plastics component B is composed of
B1: from 50 to 100% by weight of at least one semicrystalline, thermoplastic polyester based on aromatic dicarboxylic acids and on aliphatic or aromatic dihydroxy compounds and
B2: from 0 to 50% by weight of at least one thermoplastic styrene (co)polymer,
   in each case based on the polymer content of the second plastics component B, and where the first plastics component A and the second plastics component B have different constitutions. The invention further relates to a process for the production of the component.

The invention relates to a component comprising an insert part and plastics jacketing composed of at least two plastics components, where the insert part is enclosed by a plastics component A and there is a second plastics component B enclosing the first plastics component A. The invention further relates to a process for the production of this component.

Components which comprise an insert part and plastics jacketing are used by way of example when metallic insert parts are used for the integration of electronics components, e.g. in automobile technology or in aerospace technology. A leakproof or coherent bond is required in the component here, in order to prevent ingress of moisture or liquid and resultant damage to the electronic components. The component has to remain leakproof even when it is subject to temperature variations. One reason for defective leakproof properties in the coherent bond in composite structures composed of a metallic insert part with plastics jacketing can derive for example from poor wetting of the metal component by the plastics component, resulting in poor adhesion. Differences in the thermal expansion of the metallic component and of the plastics component also lead to stresses which can cause cracks.

A component in the form of a plug in which plastics jacketing encloses a metallic insert part is known by way of example from EP-B 0 249 975. In order to achieve a leakproof bond between plastic and metal, there is a flexible plastics material introduced between the exterior plastics material and the metallic insert part. The flexible plastics material is, for example, an unreinforced thermoplastic elastomer.

EP-A 1 496 587 discloses a composite component in which a flat cable is passed out from a sealed structure composed of a plastics material. In order to seal the gap where the cable emerges from the plastics material, the aperture is filled by a liquid rubber, which is then cured.

DE-C 100 53 115 also describes a passageway for a cable composed of a plastics jacket. The sealing here is achieved via a sealant which has adhesive properties both with respect to the material of the bushing and with respect to the jacket material of the lines. Examples mentioned of suitable sealants are fat, wax, resin, bitumen, or the like.

Another plug connector in which a solid jacket composed of a plastics material receives metallic pins is known from EP-A 0 245 975. A flexible plastics material is used between the metal pins and the exterior jacket, in order to achieve a leakproof bond.

WO-A 2008/099009 also discloses a component in which a plastics layer jackets an insert part. The metallic insert part in said component is first sheathed by a low-viscosity plastics composition, and, in a second step, a hard plastics component is injected around the sheathing. Suitable plastics mentioned which have the low viscosity are polyamides, aliphatic polyesters, or polyesters based on aliphatic and aromatic dicarboxylic acids and on aliphatic dihydroxy compounds.

DE-B 10 2005 033 912 discloses another casing passageway in which an electrical contact is conducted through a casing, and in which the casing passageway has been sealed in such a way as to prevent ingress of undesired substances. In order to achieve sealing, a galvanizing process is used to increase the roughness depth of the conductor element in the region of sealing.

A disadvantage of plastics sheathing of insert parts throughout the prior art is that it does not provide adequate leakproof properties, in particular when it is used under conditions of temperature change.

It is therefore an object of the present invention to provide a component which comprises an insert part and plastics jacketing, and in which the plastics jacketing provides adequate leakproof properties even during storage under conditions of temperature change.

The object is achieved via a component comprising an insert part and plastics jacketing composed of at least two plastics components, where the insert part is enclosed by a first plastics component A and there is a second plastics component B enclosing the first plastics component A, wherein the first plastics component A is composed of:

A1: from 10 to 100% by weight of at least one thermoplastic styrene (co)polymer and
A2: from 0 to 90% by weight of at least one thermoplastic (co)polyester,
in each case based on the polymer content of the first plastics component A,
and the second plastics component B is composed of
B1: from 50 to 100% by weight of at least one semicrystalline, thermoplastic polyester based on aromatic dicarboxylic acids and on aliphatic or aromatic dihydroxy compounds and
B2: from 0 to 50% by weight of at least one thermoplastic styrene (co)polymer,
   in each case based on the polymer content of the second plastics component B, and where the first plastics component A and the second plastics component B have different constitutions.

The use of the first plastics component A, which is composed of the at least one thermoplastic styrene (co)polymer and, if appropriate, of the at least one thermoplastic (co)polyester, achieves markedly improved leakproof properties when comparison is made with the plastics jacketing known from the prior art, in particular when the component is used under conditions of temperature change.

In one preferred embodiment, the first plastics component A comprises from 50 to 100% by weight of the at least one thermoplastic styrene (co)polymer, and in particular from 70 to 100% by weight. Accordingly, the proportion of the at least one thermoplastic (co)polyester is preferably from 0 to 50% by weight, and in particular from 0 to 30% by weight. In a particularly preferred embodiment, the amounts comprised are from 70 to 90% by weight of a thermoplastic styrene (co)polymer and from 10 to 30% by weight of a thermoplastic (co)polyester.

The thermoplastic styrene (co)polymer A1 has preferably been selected from the group consisting of styrene-butadiene copolymers, styrene-acrylonitrile copolymers (SAN), α-methylstyrene-styrene-acrylonitrile copolymers, styrene-acrylonitrile copolymers with particulate rubber phase composed of diene polymers or alkyl acrylates, and α-methylstyrene-styrene-acrylonitrile copolymers with particulate rubber phase composed of diene polymers or alkyl acrylates, where the proportion comprised of each of the monomer units other than styrene in the copolymers is from 15 to 40% by weight.

Component A1 generally comprises from 15 to 60% by weight, preferably from 25 to 55% by weight, in particular from 30 to 50% by weight, of particulate graft rubber, and from 40 to 85% by weight, preferably from 45 to 75% by weight, in particular from 50 to 70% by weight, of thermoplastic styrene (co)polymer, where each of the percentages by weight has been based on the total weight of particulate graft rubber and of thermoplastic (co)polymer, and together these give 100% by weight.

The thermoplastic styrene (co)polymer A1 can also comprise α-methylstyrene or n-phenylmaleimide, with a proportion of from 0 to 70% by weight.

The proportions by weight of the monomer units other than styrene, or the proportion of the α-methylstyrene or n-phenylmaleimide, is always based here on the weight of the thermoplastic styrene (co)polymer A1.

In one preferred embodiment, the styrene component A1 comprises, as rubber phase, a particulate graft rubber based on butadiene, and, as thermoplastic hard phase, copolymers composed of vinylaromatic monomers and of vinyl cyanides (SAN), in particular composed of styrene and acrylonitrile, particularly preferably composed of styrene, α-methylstyrene, and acrylonitrile.

It is preferable that acrylonitrile-butadiene-styrene polymers (ABS) are used as SAN impact-modified with a particulate graft rubber.

ABS polymers are generally impact-modified SAN polymers in which diene polymers, in particular 1,3-polybutadiene, are present in a copolymer matrix composed in particular of styrene and/or α-methylstyrene and acrylonitrile. ABS polymers and their production are known to the person skilled in the art and are described in the literature, for example in DIN EN ISO 2580-1 DE of February 2003, WO 02/00745 and WO 2008/020012, and in Modern Styrenic Polymers, Edt. J. Scheirs, Wiley & Sons 2003, pp. 305-338.

The thermoplastic polyester A2 has preferably been selected from the group consisting of polyethylene terephthalate, polytrimethylene terephthalate, polybutylene terephthalate, and copolyesters composed of one or more diacids with one or more diols and, if appropriate, with one or more lactones, and also mixtures composed of at least two of said polyesters.

Examples of suitable diacids of which the copolyester is composed are those selected from the group consisting of terephthalic acid, adipic acid, isophthalic acid, 2,6-naphthalenedicarboxylic acid, acelaic acid, sebacic acid, dodecanedioic acids, cyclohexanedicarboxylic acids, and mixtures of these.

Examples of suitable diols of which the copolyester is composed are those selected from the group consisting of 1,2-ethanediol, 1,3-propanediol, 1,4-butanediol, pentanediol, 1,6-hexanediol, 1,4-hexanediol, 1,4-cyclohexanediol, 1,4-cyclo-hexanedimethanol, neopentyl glycol, polytetrahydrofuran, and mixtures of these.

If one or more lactones is/are also used in the structure of the copolyester, these are preferably those selected from the group consisting of ε-caprolactone, hexano-4-lactone, γ-butyrolactone, and γ-valerolactone.

In one preferred embodiment, at least one of the polyesters comprised in plastics component A has a lower melting point than the polyester B1 of the second plastics component B.

Preference is given, as thermoplastic polyester A2, to a random copolyester composed of terephthalic acid (from 10-40 mol %), 1,4-butanediol (50 mol %) and adipic acid or sebacic acid (from 10-40 mol %), where the entirety of the monomers is 100% by weight. Particular preference is given to a random copolyester composed of terephthalic acid (from 15-35 mol %), 1,4-butanediol (50 mol %), and adipic acid (from 15-35 mol %), where the entirety of the monomers is 100% by weight.

Advantage of the lower melting point is that incipient melting of the first plastics component A can give a particularly leakproof bond when the second component B is injected over the material.

The first plastics component A can also comprise one or more additives. The additives here are usually those selected from the group consisting of fibrous or particulate fillers, impact modifiers, flame retardants, nucleating agents, carbon black, pigments, colorants, mold-release agents, heat-aging stabilizers, antioxidants, processing stabilizers, and compatibilizers.

Examples of suitable fibrous fillers are glass fibers, carbon fibers, or aramid fibers. Examples of particulate fillers usually used are kaolin, calcined kaolin, talc, chalk, amorphous silica, and powdered quartz. Among the fibrous or particulate fillers, particular preference is given to the particulate fillers. Minerals and glass beads are very particularly preferred, in particular glass beads. If the first plastics component A comprises glass beads, the proportion of the glass beads is preferably in the range from 0.1 to 40% by weight, based on the total weight of the first plastics component A.

To improve compatibility with the first plastics component A, the surface of the fillers can by way of example have been treated with an organic compound or with a silane compound.

Examples of suitable impact modifiers for the first plastics component A are copolymers composed of at least two monomer units selected from ethylene, propylene, butadiene, isobutene, isoprene, chloroprene, vinyl acetate, styrene, acrylonitrile, and acrylates and, respectively, methacrylates having from 1 to 18 carbon atoms in the alcohol component. Suitable impact modifiers are known by way of example from WO-A 2007/009930.

The first plastics component A can comprise amounts of from 0 to 50% by weight, based on the total weight of the first plastics component A, of flame retardants. Examples of suitable flame retardants are halogen-containing flame retardants, halogen-free flame retardants, melamine-cyanurate-based flame retardants, phosphorus-containing flame retardants, and flame retardants comprising expanded graphite.

In one particularly preferred embodiment, plastics component A comprises at least one compatibilizer. The proportion of the at least one compatibilizer is preferably in the range from 0.05 to 5% by weight, in particular in the range from 1 to 3% by weight, in each case based on the total weight of plastics component A.

The compatibilizers used can either improve the bonding of component A2 into the matrix of the styrene (co)polymer A1 or act as adhesion promoters between the first plastics component A and the second plastics component B. Examples of suitable compatibilizers are styrene (co)polymers grafted with glycidyl methacrylates, for example those described on pages 17-25 in Macromol. Symp. 2006, 233. Other suitable materials are styrene (co)polymers grafted with isocyanate groups, poly[methylene(phenylene isocyanate)], bisoxazolines, styrene copolymers grafted with oxazoline groups, or styrene copolymers grafted with maleic anhydride. Particularly suitable materials are styrene copolymers equipped with epoxy functionalities, with a proportion of methacrylic acid. Preference is given to random, epoxy-functionalized styrene-acrylic acid copolymers with a molar mass M_{w} of from 3000 to 8500 g/mol and functionalization by more than two epoxy groups per molecule chain. Particular preference is given to random, epoxy-functionalized styrene-acrylic acid copolymer with a molar mass M_{w} of from 5000 to 7000 g/mol and functionalization by more than four epoxy groups per molecule chain.

The at least one semicrystalline, thermoplastic polyester B1, based on aromatic dicarboxylic acids and on aliphatic or aromatic dihydroxy compounds, of the second plastics component B is preferably a polyalkylene terephthalate or a mixture composed of at least two different polyalkylene terephthalates. The at least one polyalkylene terephthalate here preferably has from 2 to 10 carbon atoms in the alcohol moiety.

Polyalkylene terephthalates of this type are known per se and are described in the literature. Their main chain comprises an aromatic ring, deriving from the aromatic dicarboxylic acid. The aromatic ring can also have substitution, e.g. by halogen, such as chlorine or bromine, or by C₁-C₄-alkyl groups, such as methyl, ethyl, isopropyl, n-propyl, or n-butyl, isobutyl, or tert-butyl groups.

The polyalkylene terephthalates can be produced via reaction of aromatic dicarboxylic acids, or their esters or other ester-forming derivatives, with aliphatic dihydroxy compounds, in a manner known per se.

Preferred dicarboxylic acids are 2,6-naphthalenedicarboxylic acid, terephthalic acid, and isophthalic acid, or a mixture of these. Up to 30 mol %, but of the aromatic dicarboxylic acids, preferably not more than 10 mol %, can be replaced by aliphatic or cycloaliphatic dicarboxylic acids, such as adipic acid, azelaic acid, sebacic acid, dodecanedioic acids, and/or cyclohexanedicarboxylic acids.

Among the aliphatic dihydroxy compounds, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol, neopentyl glycol, or a mixture of these.

It is particularly preferable that the semicrystalline thermoplastic polyester B1 that takes the form of polyalkylene terephthalate in the second plastics component B is a polyethylene terephthalate, polytrimethylene terephthalate, polypropylene terephthalate, polybutylene terephthalate, or a mixture composed of at least two of said polyalkylene terephthalates.

It is very particularly preferable that the semicrystalline thermoplastic polyester B1 that takes the form of polyalkylene terephthalate in the second plastics component B is a polybutylene terephthalate, or a mixture composed of polybutylene terephthalate (from 60 to 90% by weight) and polyethylene terephthalate (from 10 to 40% by weight), where the entirety of PBT and PET is 100% by weight.

The intrinsic viscosity of the polyesters A2 and B1 is generally in the range from 50 to 220 ml/g, preferably in the range from 80 to 160 ml/g (measured in 0.5% strength by weight solution in a phenol/o-dichlorobenzene mixture (ratio by weight 1:1) at 250° C. to ISO 1628).

Particular preference is given to polyesters A2 and B1 which have carboxy end group content up to 100 meq/kg of polyester, preferably up to 50 meq/kg of polyester, and in particular up to 40 meq/kg of polyester. Polyesters of this type can by way of example be produced by the process described in DE-A 44 01 055. The carboxy end group content is usually determined by titration methods, such as potentiometry.

It is moreover advantageous to use polyethylene terephthalate recyclates (also termed scrap PET), if appropriate in a mixture with polyalkylene terephthalates, such as polybutylene terephthalate.

Recyclates are generally the materials known as post-industrial recyclate or post-consumer recyclate.

Post-industrial recyclate is production waste from the polycondensation reaction or from processing, for example sprues from injection-molding processes, start-up product from injection-molding processes or extrusion processes, or edge-cuts from extruded sheets or foils.

Post-consumer recyclate is usually plastics items collected and recycled by the end consumer after use. In quantitative terms, by far the most important items are blow-molded bottles composed of polyethylene terephthalate, used by way of example for mineral water, soft drinks, and juices.

Both types of recyclate can take the form either of regrind or of pellets. In the latter case, the crude recyclates are first separated and purified and then melted and pelletized in an extruder. This mostly facilitates handling, free-flowing properties, and ease of metering for further processing steps.

Recyclates can be used either in the form of pellets or in the form of regrind, and the maximum edge length here should be 10 mm, preferably 8 mm.

Because of the hydrolytic cleavage of polyesters during processing, e.g. caused by traces of moisture, it is preferable to predry the recyclate. The residual moisture content after drying is preferably less than 0.2%, in particular less than 0.05%.

Another group which may be mentioned is that of fully aromatic polyesters which derive from aromatic dicarboxylic acids and from aromatic dihydroxy compounds.

Suitable aromatic dicarboxylic acids are the compounds already described for the polyalkylene terephthalates. The mixtures preferably used are composed of from 5 to 100 mol % of isophthalic acid and from 0 to 95 mol % of terephthalic acid, in particular mixtures of from about 50 to about 80% of terephthalic acid and from 20 to about 50% of isophthalic acid.

The aromatic dihydroxy compounds preferably have the general formula

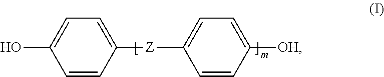

where Z is an alkylene or cycloalkylene group having up to 8 carbon atoms, an arylene group having up to 12 carbon atoms, a carbonyl group, a sulfonyl group, an oxygen or sulfur atom, or a chemical bond, and m is from 0 to 2. The phenylene groups of the dihydroxy compounds may also have substitution by C₁-C₈-alkyl or -alkoxy groups and fluorine, chlorine or bromine.

Examples of parent compounds are dihydroxybiphenyl, di(hydroxyphenyl)alkane, di(hydroxyphenyl)cycloalkane, di(hydroxyphenyl)sulfide, di(hydroxyphenyl)ether, di(hydroxyphenyl)ketone, di(hydroxyphenyl)sulfoxide, α,α′-di(hydroxyphenyl)-dialkylbenzene, di(hydroxyphenyl)sulfone, di(hydroxybenzoyl)benzene, resorcinol and hydroquinone, and also the ring-alkylated and ring-halogenated derivatives of these. Among these, preference is given to 4,4′-dihydroxydiphenyl, 2,4-di(4′-hydroxyphenyl)-2-methylbutane, α,α′-di(4-hydroxyphenyl)-p-diisopropylbenzene, 2,2-di(3′-methyl-4′-hydroxyphenyl)propane, and 2,2-di(3′-chloro-4′-hydroxyphenyl)propane, and in particular to 2,2-di(4′-hydroxyphenyl)propane, 2,2-di(3′,5-dichlorodihydroxyphenyl)-propane, 1,1-di(4′-hydroxyphenyl)cyclohexane, 3,4′-dihydroxybenzophenone, 4,4′-dihydroxydiphenyl sulfone and 2,2-di(3′,5′-dimethyl-4′-hydroxyphenyl)propane and mixtures thereof.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester. It is also possible to use polyester block copolymers, such as copolyetheresters. Products of this type are known per se and are described in the literature, e.g. in U.S. Pat. No. 3,651,014. Corresponding products are also available commercially, e.g. Hytrel® (DuPont).

Mixtures of polyalkylene terephthalates B1 with styrene copolymers B2 can likewise be used. These preferably comprise from 60 to 90% by weight of polyalkylene terephthalate and from 10 to 40% by weight of the styrene copolymer. Particular preference is given to mixtures with from 60 to 80% by weight of polyalkylene terephthalate and from 20 to 40% by weight of styrene copolymer.

If the second plastics component B comprises at least one thermoplastic styrene (co)polymer B2, this has preferably been selected from the group consisting of acrylonitrile-styrene-acrylate (ASA), acrylonitrile-butadiene-styrene copolymers (ABS), styrene-acrylonitrile copolymers (SAN), and mixtures thereof.

One preferred embodiment comprises, as styrene copolymer B2, a styrene-acrylonitrile-acrylic acid copolymer (ASA) having the following constitution: from 20 to 40% by weight of styrene, from 20 to 40% by weight of acrylonitrile, and from 20 to 40% by weight of acrylic acid, where the entirety of the individual monomers is 100% by weight.

In one particularly preferred embodiment, the polyalkylene terephthalate B1 is polybutylene terephthalate and the styrene copolymer B2 is a styrene-acrylonitrile-acrylic acid copolymer (ASA) having the following constitution: from 20 to 40% by weight of styrene, from 20 to 40% by weight of acrylonitrile, and from 20 to 40% by weight of acrylic acid, where the entirety of the individual monomers is 100% by weight. The proportion of B1 is from 60 to 80% by weight and the proportion of B2 is from 20 to 40% by weight, and the total of the proportions is 100% by weight, based on the total weight of the plastic of polymer component B.

The second plastics component B can also comprise, alongside the at least one semicrystalline, thermoplastic polyester B1 and, if appropriate, the at least one thermoplastic styrene (co)polymer B2, one or more additives. The additives here are those selected from the group consisting of fibrous or particulate fillers, impact modifiers, flame retardants, nucleating agents, carbon black, pigments, colorants, mold-release agents, heat-aging stabilizers, antioxidants, processing stabilizers, and compatibilizers.

Examples of suitable fibrous or particulate fillers are carbon fibers, glass fibers, glass beads, amorphous silica, asbestos, calcium silicate, calcium metasilicate, magnesium carbonate, calcium carbonate, kaolin, chalk, powdered quartz, mica, barium sulfate, and feldspar. The preferred amounts of the fillers used here are from 0.1 to 50% by weight, particularly from 10 to 40% by weight. Preference is given to fibrous fillers and among these preference is in particular given to glass fibers. The proportion of the fillers here is based on the total weight of the second plastics component B.

To improve compatibility, the surface of the fillers can have been treated with an organic compound or with a silane compound.

Flame retardants which can be comprised in the second plastics component B are preferably the same as those that can also be comprised in the first plastics component A.

Alongside the additives mentioned, other materials that can also be comprised are stabilizers, oxidation retarders, agents to counteract decomposition by heat and decomposition due to UV radiation, lubricants and mold-release agents, colorants, such as dyes and pigments (also carbon blacks), nucleating agents, plasticizers, etc. The material can also comprise from 0 to 2% by weight, based on the total weight of the second plastics component B, of fluorine-containing ethylene polymers.

An example of the component is the type of plastics part used in electrical engineering, a mechatronic component, or a plastics casing with plug-in contacts.

An example of the insert part enclosed by the plastics jacketing is a stamped grid. In that case, the component can be used for example as plug connector. The insert part can moreover be a wire, a round conductor, a flat conductor, a flexible foil, or a printed circuit board.

If the component is used in the automobile industry sector, the insert part can, for example, also be a retaining strap, a door latch, a lock, a threaded bush, an antifriction bearing, a panel, a wire for stabilizers, or a component composed of diecast zinc or diecast aluminum for a door-securing unit. It is moreover also possible that the component is a blade for a knife, for scissors, for a scalpel, or else for a screwdriver.

The insert part has preferably been manufactured from a metal. Examples of suitable metals from which the insert part has been manufactured are copper and copper-containing alloys, such as CuSn6, CuSn0,15, CuBe, CuFe, CuZn37, CuSn4Zn6Pb3-C-GC (gunmetal) or CuZn39Pb3 (brass), aluminum and aluminum-containing alloys, such as AISi12Cu1, AlSi10Mg, titanium, stainless steel, lead-free metals, and metal alloys, or materials with a tin coating.

The invention further provides a process for the production of a component comprising an insert part and plastics jacketing composed of at least two plastics components, where the process comprises the following steps:
(a) sheathing of an insert part with a first plastics component A, where the first plastics component A is composed of:
   A1: from 10 to 100% by weight of at least one thermoplastic styrene (co)polymer and
   A2: from 0 to 50% by weight of at least one thermoplastic (co)polyester,
   in each case based on the polymer content of the first plastics component A,
(b) molding of exterior sheathing composed of a second plastics component B, where the second plastics component B is composed of:
   B1: from 50 to 100% by weight of at least one semicrystalline, thermoplastic polyester based on aromatic dicarboxylic acids and on aliphatic or aromatic dihydroxy compounds and
   B2: from 0 to 50% by weight of at least one thermoplastic styrene (co)polymer,
   in each case based on the polymer content of the second plastics component B,
      where either the insert part is first sheathed with the first plastics component A and then the second plastics component B is applied or the exterior sheathing B is first molded, and then the first plastics component A is charged to a cavity between the exterior sheathing composed of the second plastics component B and the insert part, in order to form the sheathing of the insert part.

In one preferred embodiment, the first plastics component A comprises from 50 to 100% by weight of the at least one thermoplastic styrene (co)polymer and in particular from 70 to 100% by weight. Accordingly, the proportion of the at least one thermoplastic (co)polyester is preferably from 0 to 50% by weight and in particular from 0 to 30% by weight. Particular preference is given to an embodiment comprising from 70 to 90% by weight of a thermoplastic styrene (co)polymer and from 10 to 30% by weight of a thermoplastic (co)polyester.

In one preferred embodiment, an injection-molding process is used for the sheathing of the insert part with the first plastics component A in a step (a). For this, the insert part is placed in an injection mold. Once the insert part has been placed, the mold is closed and the plastics molding composition is injected into the mold. The plastics molding composition at least partially sheaths the insert part and forms an adhesive bond with the insert part. The result is a leakproof bond between the insert part and the plastics component A. Injection of the plastics molding composition here generally takes place at the pressures conventional in injection molding. However, if, for example, non-uniform injection around the insert part can cause it to deform, it is preferable that the maximum pressure at which the injection of component A takes place in the mold is less than 900 bar, more preferably less than 600 bar. The low injection pressure avoids deformation of the insert part when the material is injected around it. Once the material has been injected around the insert part, the first plastics component A hardens and becomes solid. A further advantage of injecting the first plastics component A around the insert part is that the insert part is stabilized by said plastics sheathing.

A very wide variety of shapes can be realized when the insert part is sheathed by the first plastics component A. By way of example, it is possible to realize a rectangular, rhombic, pentagonal, octagonal, circular, or elliptical cross section. If the plastics sheathing composed of the first plastics component A has corners, these can also be rounded corners.

Junctions between the surfaces of the sheathing composed of the first plastics component A can be obtuse-angled, acute-angled, or rounded junctions. There can also be distinct melt lips, i.e. thin protruding regions composed of the first plastics component A. These are then melted and deformed when the second plastics component B is injected over the material. A coherent bond is thus produced.

There can also be protruding regions designed on the material injected around the insert part and composed of the first plastics component A. By way of example, the first plastics component A can enclose the insert part with a cross section in the shape of a double T. An interlock bond can be achieved via the protruding regions when the first plastics component A is injected around the material in this way. Since injection of the second plastics component B over the first plastics component A generally causes incipient melting of the latter, the shape of the material previously injected, composed of the first plastics component A, can generally change if the processing temperature of the second plastics component B is above the melting point or the softening point of the first plastics component A. It is also possible that the material previously injected, composed of the first plastics component A, is deformed via the pressure of the injected melt when the second plastics component B is injected around the material. By way of example, sharp edges of the material previously injected, composed of the first plastics component A, can be rounded.

Once the insert part has been sheathed with the first plastics component A, the insert part thus sheathed is sheathed with the second plastics component B. The sheathing with the second plastics component B preferably likewise takes place via an injection-molding process. The injection-molding process here is generally carried out with the pressures conventional in injection molding. If the plastics molding composition has been injected with low injection pressure, the pressure in the mold here is generally higher than the maximum pressure in the mold in step (a). During injection of the second plastics component B, the surface of hardened first plastics component A preferably undergoes incipient melting, thus producing particularly good adhesion between the first plastics component A and the second plastics component B.

The sheathing of the insert part with the first plastics component A in step (a) and the molding of the exterior sheathing composed of the second plastics component B in step (b) can take place in the same injection mold. For this, it is necessary that the injection mold initially encloses a cavity which corresponds to the shape of the insert part with the sheathing composed of the first plastics component A. The mold must then open in such a way that the unoccupied shape corresponds to the shape of the finished component. The person skilled in the art is aware of appropriate molds.

However, as an alternative it is also possible that the sheathing of the insert part with the first plastics component A in step (a) takes place in a first mold and that the molding of the exterior sheathing composed of the second plastics component B in step (b) takes place in a second mold. In that case it is necessary that the insert part sheathed with the first plastics component A is removed from the first mold and placed in the second mold prior to injecting of the second plastics component B around the material. If the intention is to avoid deformation of the sheathing of the insert part composed of the first plastics component A, it is necessary that the first plastics component A exhibits sufficient mechanical resistance to the approaching flow of melt of the second plastics component B. This requires sufficient stiffness and strength, and these are dependent on the degree of hardening of the first plastics component A and on the injection pressure of the second plastics component B. In order to avoid the necessity for cleaning of the injection-molding machine after every injection procedure, in order to change the material, it is preferable that two different injection-molding machines or plastifying units are used for the first plastics component A and the second plastics component B. If the sheathing in step (a) and the molding of the exterior sheathing in step (b) take place with the same mold, it is possible that the mold has simultaneous connection to both injection-molding machines. An alternative possibility is to begin by connecting the mold to the injection-molding machine which injects the first plastics component A and then to connect the mold to the injection-molding machine that injects the second plastics component B around the insert part with the sheathing composed of the first plastics component A. Examples of conventional injection-molding machines used for this purpose are injection-molding machines with turntable mold. These have, by way of example, an opposite arrangement of the cylinders, and in each case the mold is rotated toward the cylinder from which the next material will be injected. If two different molds are used, each of these preferably has connection to an injection-molding machine. A suitable injection-molding machine here is any desired injection-molding machine known to the person skilled in the art.

It is possible that, in step (b), the second plastics component B sheaths only parts of the insert part sheathed with the first plastics component A. In that case it is preferable that the regions around which the second plastics component B is injected are those having an external surface, since sheathing with the second plastics component B ensures that the molding has dimensional stability. Another possible alternative is, of course, that the second plastics component B is injected around the entire insert part with the sheathing composed of the first plastics component A.

In that version of the process which comprises first molding the exterior sheathing composed of the second plastics component B, where regions of the insert part are not sheathed, and, in a second step, sheathing the unsheathed regions of the insert part with the first plastics component A, the preferred method of sheathing of the insert part with the second plastics component B is that said component sheaths the insert part in those regions in which external surfaces are present. The regions onto which the first plastics component A is cast preferably have no outward-facing areas. This method ensures that the resultant component has geometric and dimensional stability. The sheathing of the insert part with the second plastics component B preferably takes place via an injection-molding process. For this, the insert part is placed in an injection mold, and the second plastics component B is then injected around the same. To avoid penetration of the second plastics component B into the regions intended to be excluded, the mold is in contact with the insert part in those regions. Once the insert part has been sheathed with the second plastics component B, the regions that are intended for sheathing with the first plastics component A are rendered accessible. For this, it is possible either to have movable parts provided in the mold which initially form the exclusions and then render the exclusions accessible so that they can be cast by the first plastics component A, or to remove, from the mold, the insert part around which the second plastics component B has been injected, and to place it in a second mold in which the regions intended for sheathing with the first plastics component A have been rendered available. The sheathing with the first plastics component A preferably likewise takes place via an injection-molding process. This is generally carried out with the pressures conventional in injection-molding processes. If, for example, non-uniform injection around the insert part can cause it to deform, the injection-molding process for the first plastics component A is preferably carried out at a lower pressure than the injection-molding process used to inject the second plastics component B around the insert part. The pressure for the sheathing of the insert part with the first plastics component A is then preferably below 900 bar, with preference below 600 bar. The preferred method of achieving a leakproof bond between the first plastics component A and the second plastics component B is that the melt of the first plastics component A causes incipient melting on the surface of the plastics component B, so that, for example, interdiffusion produces particularly good adhesion between the first plastics component A and the second plastics component B. A further possibility is chemical and/or mechanical bonding between the first plastics component A and the second plastics component B. A chemical bond can be produced, for example, via reaction of the polymer components of the first plastics component A and of the second plastics component B, for example by forming covalent bonds between the first plastics component A, or one component of the first plastics component A, and the second plastics component B, or one component of the second plastics component B. Another possibility always available is to design the process in such a way as to give not only good adhesion but also an interlock bond between the first plastics component A and the second plastics component B.

The melt temperature of the first plastics component A during the first injection of material around the insert part is preferably in the region of the usual temperature for processing of the underlying polymer by injection molding. If the first plastics component A is a mixture composed of two polymers, the melt temperature is selected to be sufficiently high that both components are liquid.

A higher processing temperature leads to a more free-flowing melt which can provide better wetting of the surface of the insert part, thus permitting achievement of higher bond strength between the material of the insert part and of the first plastics component A. However, an excessive melt temperature can lead to thermal degradation of the first plastics component A or of one of its components A1 or A2.

When the second plastics component B is then injected over the component, the melt temperature of the second plastics component B is preferably in the region of the usual temperature for processing of the underlying polymer by injection molding. If the second plastics component B is a mixture composed of two polymers, the melt temperature is selected to be sufficiently high that both components are liquid.

A higher processing temperature leads to a more free-flowing melt which can provide better wetting and/or incipient melting of the surface of the sheathing composed of the first plastics component A, thus permitting achievement of higher bond strength between the second plastics component B and the first plastics component A. As a function of the thermodynamic compatibility of the two components, a boundary layer of varying thickness can arise, improving leakproof properties via interdiffusion, and providing a coherent bond between plastics components A and the second plastics component B. The melt temperature of the second plastics component B is preferably not set so high that the sheathing composed of the first plastics component A is entirely melted and ablated. It is also preferable that the injection pressure for the second plastics component B is selected in such a way that the sheathing composed of the first plastics component A is not excessively deformed, or, in the worst case, ablated.

The component of the invention is by way of example the type of plastics part used in electrical engineering. It is also possible that the component is a mechatronic component or a plastics casing with plug-in contacts. Components of this type are used by way of example as sensors, for example as oil sensors, wheel-rotation-rate sensors, pressure sensors, etc., as electronics casings, as control casings, for example in the ABS sector, the ESP sector, the transmission-system sector, or the airbag sector, or in the engine-control system of motor vehicles. The components can also be used by way of example as window-lifter modules or for the headlamp control system. The components of the invention can also be used outside of the automobile industry by way of example as sensors, as fill-level indicators, or as pipeline units. Examples of another suitable use of the components of the invention are electronics components in household devices. Examples of suitable components are relays, coil formers, switch parts, magnetic valves, electrical hand tools, plug devices, or plug connectors.

A feature of the component of the invention, composed of the insert part with the sheathing composed of the first plastics component A and the exterior sheathing composed of the second plastics component B, is that it is leakproof along both interfaces, i.e. the interface between insert part and sheathing composed of the first plastics component A and the interface between the first plastics component A and the second plastics component B. A leakproof bond here means that the leakage rate in a test under changing climatic conditions using at least 200 cycles in which the component to be tested is subjected to an alternating temperature of −40° C. and +150° C. is smaller than 0.5 cm³/min. The leakage rate is usually determined by a pressure-difference method with a test pressure of 0.5 bar.

### EXAMPLES

Test specimens are produced from an insert part composed of CuSn6 sheathed with a first plastics component A and with a second plastics component B.

To produce the test specimens, a punching die is first used to punch the insert part from strips of CuSn6. The insert part has a rectangular frame, and there is also a central fillet here connecting the opposite short sides of the frame. The length of the insert part produced is 30 mm, its width is 10.5 mm, and its height is 0.5 mm. The length of the grooves between the exterior fillets of the frame and the central fillet is 25 mm, and the width of the grooves is 3 mm.

After the punching process, the punched parts are cleaned with acetone to remove oils and impurities. An injection-molding machine with screw diameter 18 mm is used to produce the test specimens (Allrounder 270S from Arburg). The clamping force of the mold is 500 kN, and the injection pressure is 1500 bar. Material in the shape of a parallelepiped is injected around the central region of the insert part with the three fillets, whereupon the sheathing composed of the second plastics component B completely encloses the first plastics component A. The length of the sheathing composed of the first plastics component A is 15 mm, its width is 4.5 mm, and its thickness is 1.5 mm, while the length of the sheathing composed of the second plastics component B, which completely encloses the first plastics component A, is 20 mm, its width is 13 mm, and its thickness is 4.5 mm. The injection of the first plastics component A onto the insert part and the injection of the second plastics component B onto the insert part sheathed with the first plastics component A take place approximately at the mold-parting line.

In order to test the materials, the components with the sheathing composed of the first plastics component A and with the sheathing composed of the second plastics component B are subjected to temperature-shock stressing, using up to 500 cycles.

The following schedule applied here for each temperature-shock cycle: 15 minutes of storage at 150° C., temperature change to −40° C. within 10 seconds, 15 minutes of storage at −40° C., temperature change to 150° C. within 10 seconds. The temperature-shock treatment took place in a VT 7030S2 temperature-shock cabinet from \kitsch. Leakproof properties were measured by means of a differential-pressure method prior to stressing, and also after 100, 200, and, if appropriate, 500 cycles.

For the differential-pressure test, two volumes are subjected to the same pressure, a test volume and a control volume. If the test volume is not leakproof, a pressure difference arises and can be directly measured. As an alternative, the pressure drop per unit of time can be measured. In the present embodiment, the exterior periphery of the test specimen was tightly clamped into a holder and pressure was applied to the underside of the test specimen. The system was sealed by a rubber sealing ring. A blind trial using a solid test specimen composed of component B1 was used to demonstrate that the only leaks that cause leakage from the test volume are those arising in the direction of the insert part, between insert part and the sheathing composed of the first plastics component A, or between the sheathing composed of the first plastics component A and the sheathing composed of the second plastics component B. The test medium used was air. The test volume Vₜₑₛₜ was 36 ml. The time required to fill the volumes with a test pressure of 0.5 bar was 5 seconds. After 10 seconds of standing time, the pressure drop was measured for Δtₜₑₛₜ=5 seconds. The volumes were then evacuated within 2 seconds. The differential pressure drop was used in the Boyle-Marriotte equation to calculate the leakage rates:

$${Q}_{leak} [ ml \text{/} min ] = \frac{{V}_{test} \cdot Δ p}{Δ {t}_{test} \cdot 1000 mbar}$$

A universal testing machine (Zwick 1446) was used in the tensile test to measure the force needed to extract the insert part from the sheathing composed of plastics components A and B. For this, the plastics sheathing of the injection-molded part was clamped into the machine and subjected to tension at the stamped grid, in parallel to the direction of the grid. The force that has to be exerted to move the stamped grid relative to the plastics sheathing was measured.

Table 1 collates the results.

TABLE 1
Experimental results

| | | Comp. | Inv. | Inv. | Inv. | Inv. | Inv. | Inv. | Comp. |
|---|---|---|---|---|---|---|---|---|---|
| Tab. 4 | | ex. 1 | ex. 1 | ex. 2 | ex. 3 | ex. 4 | ex. 5 | ex. 6 | ex. 2 |
| A1 | [% by | 100 | | | | | | | |
| | wt.] | | | | | | | | |
| A2 | [% by | | 100 | | | | | | |
| | wt.] | | | | | | | | |
| A3 | [% by | | | 100 | 70 | 90 | 97 | | |
| | wt.] | | | | | | | | |
| A4 | [% by | | | | 30 | | | | |
| | wt.] | | | | | | | | |
| A5 | [% by | | | | | | | | |
| | wt.] | | | | | | | | |
| A6 | [% by | | | | | 10 | | | |
| | wt.] | | | | | | | | |
| A7 | [% by | | | | | | 3 | | |
| | wt.] | | | | | | | | |
| A8 | [% by | | | | | | | 100 | |
| | wt.] | | | | | | | | |
| A9 | [% by | | | | | | | | 100 |
| | wt.] | | | | | | | | |
| A10 | | | | | | | | | |
| B1 | [% by | 100 | 100 | 100 | 100 | 100 | 100 | 100 | 100 |
| | wt.] | | | | | | | | |
| B2 | | | | | | | | | |
| B3 | | | | | | | | | |
| Leakage rate after | [ml/min] | 0.3 | 0.3 | 0.33 | 0.25 | 0.1 | 0.16 | 0.24 | 0.4 |
| injection molding | | | | | | | | | |
| SD | [ml/min] | 0.1 | 0.1 | 0.05 | 0.05 | 0.02 | 0.04 | 0.06 | 0.2 |
| Leakage rate after | [ml/min] | 2.7 | 0.3 | 0.3 | 0.3 | 0.5 | 0.2 | 0.2 | 4 |
| 100 cycles | | | | | | | | | |
| SD | [ml/min] | 0.7 | 0.2 | 0.2 | 0.1 | 0.2 | 0.1 | 0.1 | 0.8 |
| Leakage rate after | [ml/min] | — | 0.8 | 0.1 | 0.3 | 0.7 | 0.2 | 0.2 | — |
| 500 cycles | | | | | | | | | |
| SD | [ml/min] | — | 0.4 | 0.1 | 0.09 | 0.3 | 0.1 | 0.1 | — |
| Extraction force | [N] | 160 | — | 230 | — | — | 280 | — | — |
| after injection | | | | | | | | | |
| molding | | | | | | | | | |
| Extraction force | [N] | 625 | — | 700 | — | — | 750 | — | — |
| after 500 cycles | | | | | | | | | |

| | | Comp. | Comp. | Comp. | Inv. | Inv. | Inv. |
|---|---|---|---|---|---|---|---|
| Tab. 4 | | ex. 3 | ex. 4 | ex. 5 | ex. 7 | ex. 8 | ex. 9 |
| A1 | [% by | | | 70 | | | |
| | wt.] | | | | | | |
| A2 | [% by | | | | | | |
| | wt.] | | | | | | |
| A3 | [% by | | | | 70 | 70 | 70 |
| | wt.] | | | | | | |
| A4 | [% by | 100 | | 30 | 30 | 30 | |
| | wt.] | | | | | | |
| A5 | [% by | | 100 | | | | |
| | wt.] | | | | | | |
| A6 | [% by | | | | | | |
| | wt.] | | | | | | |
| A7 | [% by | | | | | | |
| | wt.] | | | | | | |
| A8 | [% by | | | | | | |
| | wt.] | | | | | | |
| A9 | [% by | | | | | | |
| | wt.] | | | | | | |
| A10 | | | | | | | 30 |
| B1 | [% by | 100 | 100 | 100 | | | 100 |
| | wt.] | | | | | | |
| B2 | | | | | 100 | | |
| B3 | | | | | | 100 | |
| Leakage rate after | [ml/min] | — | 1.1 | 0.13 | 0.28 | 0.2 | 0.3 |
| injection molding | | | | | | | |
| SD | [ml/min] | — | 0.3 | 0.06 | 0.08 | 0.1 | 0.07 |
| Leakage rate after | [ml/min] | — | — | 2.3 | 0.4 | 0.3 | 0.3 |
| 100 cycles | | | | | | | |
| SD | [ml/min] | — | — | 0.6 | 0.1 | 0.1 | 0.1 |
| Leakage rate after | [ml/min] | — | — | — | 0.3 | 0.35 | 0.2 |
| 500 cycles | | | | | | | |
| SD | [ml/min] | — | — | — | 0.1 | 0.05 | 0.1 |
| Extraction force | [N] | — | — | — | — | — | — |
| after injection | | | | | | | |
| molding | | | | | | | |
| Extraction force | [N] | — | — | — | — | — | — |
| after 500 cycles | | | | | | | |

Component A1 is a random copolyamide composed of the monomers adipic acid (15% by weight), hexamethylenediamine (15% by weight), ε-caprolactam (35% by weight), and 4,4′-diaminodicyclohexylmethane (35% by weight). The intrinsic viscosity of the material is 120 ml/g, measured on a 0.5 g/100 ml solution in 96% [w/w] H₂SO₄ to ISO 307. Its Vicat softening point is 68° C., determined to EN ISO 306:2004 and its modulus of elasticity is 2500 MPa, determined to DIN EN ISO 527-2 DE.

Component A2 is a copolymer composed of the monomers styrene (30% by weight), α-methylstyrene (25% by weight), and acrylonitrile (25% by weight), comprising a particulate butyl acrylate phase (20% by weight), with modulus of elasticity of 2500 MPa (ISO 527-2) and Vicat softening point 104° C. to ISO 306.

Component A3 is a copolymer composed of the monomers styrene (40% by weight), α-methylstyrene (30% by weight), and acrylonitrile (20% by weight), comprising a butadiene phase (10% by weight), with modulus of elasticity of 2400 MPa and Vicat softening point 115° C.

Component A4 is a random copolyester composed of terephthalic acid (25 mol %), 1,4-butanediol (50 mol %), and adipic acid (25 mol %), with melting point from 110 to 120° C. (DSC measurement to ISO 11357-3) and Shore D hardness 32, determined to ISO 868. The Vicat softening point is 91° C., measured to EN ISO 306:2004.

Component A5 is a polybutylene terephthalate with intrinsic viscosity 130 ml/g, measured in 0.5% solution in phenol/o-dichlorobenzene (1:1) to ISO 1628. The modulus of elasticity of the material is 2500 MPa (ISO 527-2) and its melting range is from 220 to 225° C. (DSC measurement to ISO 11357-3).

Component A6 is a polybutylene terephthalate with intrinsic viscosity 107 ml/g, measured in 0.5% solution in phenol/o-dichlorobenzene (1:1) to ISO 1628. The modulus of elasticity of the material is 2500 MPa (ISO 527-2) and its melting range is from 220 to 225° C. (DSC measurement to ISO 11357-3).

Component A7 is an epoxy-functionalized styrene-acrylic acid copolymer with molar mass M_{w} of 6800 g/mol and with functionalization by more than four epoxy groups per molecule chain. The glass transition temperature is 54° C.

Component A8 comprises 70% by weight of component A3 and 30% by weight of solid glass microbeads with average diameter from 12 to 26 μm (measured using CILAS).

Component A9 is a polybutylene terephthalate with 30% by weight of solid glass beads. The intrinsic viscosity of the material is 113 ml/g, measured in 0.5% solution in phenol/o-dichlorobenzene (1:1) to ISO 1628, its modulus of elasticity is 4000 MPa (ISO 527-2), and its melting range is from 220 to 225° C. (DSC measurement to ISO 11357-3).

Component A10 is a random copolyester composed of terephthalic acid (25 mol %), 1,4-butanediol (50 mol %), and sebacic acid (25 mol %) with melting point from 100 to 115° C. (DSC measurement to ISO 11357-3). The Vicat softening point is from 70 to 85° C., measured to EN ISO 306:2004.

Component B1 is a polybutylene terephthalate with 30% by weight of glass fibers with intrinsic viscosity 102 g/ml, measured in 0.5% solution in phenol/o-dichlorobenzene (1:1) to ISO 1628. It also comprises 0.1% by weight of a furnace black with average particle size from 10 to 35 nm (CILAS) and with BET surface area of from 110 to 120 m²/g (ISO 9277), and also 0.5% by weight of pentaerythritol tetrastearate as lubricant. The modulus of elasticity of the material is 10 000 MPa (ISO 527-2) and its melting range is from 220 to 225° C. (DSC measurement to ISO 11357-3). The diameter of the glass fibers is 10 μm.

Component B2 is a blend composed of polybutylene terephthalate and polyethylene terephthalate (30% of PET, based on the polymer content of component B2), comprising 30% by weight of glass fibers with intrinsic viscosity 105 g/ml, measured in 0.5% solution in phenol/o-dichlorobenzene (1:1) to ISO 1628. B2 also comprises 0.1% by weight of a furnace black with average particle size from 10 to 35 nm (CILAS) and with BET surface area of from 110 to 120 m²/g (ISO 9277), and also 0.5% by weight of pentaerythritol tetrastearate as lubricant. The modulus of elasticity of the material is 10 500 MPa (ISO 527-2) and its melting range is from 220 to 250° C. (DSC measurement to ISO 11357-3). The diameter of the glass fibers is 10 μm.

Component B3 is a blend composed of polybutylene terephthalate and of a styrene-acrylonitrile-acrylic acid copolymer (ASA) (30% of ASA, based on the polymer content of component B3), comprising 30% by weight of glass fibers, with intrinsic viscosity 105 g/ml, measured in 0.5% solution in phenol/o-dichlorobenzene (1:1) to ISO 1628. The constitution of the ASA is 45% by weight of styrene, 10% by weight of acrylonitrile, 45% by weight of acrylic acid. B3 also comprises 0.1% by weight of a furnace black with average particle size from 10 to 35 nm (CILAS) and with BET surface area of from 110 to 120 m²/g (ISO 9277), and also 0.5% by weight of pentaerythritol tetrastearate as lubricant. The modulus of elasticity of the material is 9700 MPa (ISO 527-2) and its melting range is from 220 to 225° C. (DSC measurement to ISO 11357-3). The diameter of the glass fibers is 10 μm.

Comp. ex. in the table means comparative example, and Inv. ex. means example of the invention. SD in table 1 means standard deviation.

Table 2 collates the processing conditions for the sheathing composed of the first plastics component A of each of the comparative examples and examples of the invention.

TABLE 2
Processing conditions for the first plastics component A

| | Comp. | Inv. | Inv. | Inv. | Inv. | Inv. | Inv. |
|---|---|---|---|---|---|---|---|
| | ex. 1 | ex. 1 | ex. 2 | ex. 3 | ex. 4 | ex. 5 | ex. 6 |
| Melt temperature [° C.] | 270 | 250 | 250 | 250 | 250 | 250 | 250 |
| Mold temperature [° C.] | 30 | 60 | 60 | 60 | 60 | 60 | 60 |
| Hold pressure [bar] | 700 | 700 | 700 | 600 | 600 | 600 | 600 |
| Injection rate [mm/s] | 160 | 160 | 160 | 160 | 160 | 160 | 160 |
| Cooling time [s] | 25 | 20 | 20 | 25 | 20 | 20 | 20 |
| Hold pressure time [s] | 5 | 5 | 5 | 5 | 5 | 5 | 5 |
| | Comp. | Comp. | Comp. | Comp. | Inv. | Inv. | Inv. |
| | ex. 2 | ex. 3 | ex. 4 | ex. 5 | ex. 7 | ex. 8 | ex. 9 |
| Melt temperature [° C.] | 260 | 170 | 250 | 210 | 250 | 250 | 250 |
| Mold temperature [° C.] | 60 | 30 | 60 | 40 | 60 | 60 | 60 |
| Hold pressure [bar] | 700 | 600 | 600 | 700 | 600 | 600 | 600 |
| Injection rate [mm/s] | 160 | 120 | 160 | 160 | 160 | 160 | 160 |
| Cooling time [s] | 15 | 25 | 25 | 35 | 25 | 25 | 25 |
| Hold pressure time [s] | 5 | 5 | 5 | 5 | 5 | 5 | 5 |

The parameters listed in table 3 apply to the formation of the exterior sheathing composed of the second plastics component B.

TABLE 3
Processing parameters for
second plastics component B

| | B1 | B2 | B3 |
|---|---|---|---|
| Melt temperature [° C.] | 260 | 270 | 260 |
| Mold temperature [° C.] | 80 | 80 | 80 |
| Hold pressure [bar] | 700 | 650 | 700 |
| Injection rate [mm/s] | 160 | 160 | 160 |
| Cooling time [s] | 12 | 12 | 12 |
| Hold pressure time [s] | 5 | 5 | 5 |

The examples show the improvement in the properties of a component composed of a metallic insert part sheathed with a first plastics component A and with a second plastics component B when styrene (co)polymers are used as first plastics component A or as constituent of first plastics component A. Particularly good properties are shown by mixtures composed of styrene (co)polymer and (co)polyester (examples 3, 4, and 9 of the invention, compared with comparative examples 1 and 6). Comparative examples 3 and 4 used injection moldings with straight (co)polyesters from examples 3 and 4 of the invention, and the corresponding injection-molded parts were either impossible to produce (comparative example 3) or exhibited high leakages even directly after injection molding (comparative example 4).

Addition of an adhesion promoter to styrene copolymers A1 of first plastics component A increases extraction force prior to and after thermal stressing, with the same good leakproof properties (example 5 of the invention compared with example 2 of the invention).

Glass beads as filler in first plastics component A likewise increase the leakproof properties of the component, in particular after thermal stressing (example 6 of the invention compared with example 2 of the invention). In contrast, a bond with straight glass-bead-filled polyester as first plastics component A fails after thermal storage (comparative example 2).

As far as the sheathing composed of second plastics component B is concerned, mixtures of polyesters (example 7 of the invention) or polyester and styrene copolymer (example 8 of the invention) can achieve leakproof properties of the bond just as good as those achieved with straight polyester (cf. example 3 of the invention).

1-15. (canceled)

16. A component comprising an insert part and plastics jacketing composed of at least two plastics components, where the insert part is enclosed by a first plastics component A and there is a second plastics component B enclosing the first plastics component A, wherein the first plastics component A is composed of:
A1: from 10 to 100% by weight of at least one thermoplastic styrene (co)polymer and
A2: from 0 to 90% by weight of at least one thermoplastic (co)polyester,
in each case based on the polymer content of the first plastics component A,
and the second plastics component B is composed of
B1: from 50 to 100% by weight of at least one semicrystalline, thermoplastic polyester based on aromatic dicarboxylic acids and on aliphatic or aromatic dihydroxy compounds and
B2: from 0 to 50% by weight of at least one thermoplastic styrene (co)polymer,
in each case based on the polymer content of the second plastics component B, and where the first plastics component A and the second plastics component B have different constitutions.

17. The component according to claim 16, wherein the thermoplastic styrene (co)polymer A1 has been selected from the group consisting of styrene-butadiene copolymers, styrene-acrylonitrile copolymers, α-methylstyrene-acrylonitrile copolymers, styrene-acrylonitrile copolymers with particulate rubber phase composed of diene polymers or alkyl acrylates and α-methylstyrene-acrylonitrile copolymers with particulate rubber phase composed of diene polymers or alkyl acrylates, where the proportion comprised of each of the monomer units other than styrene in the copolymers is from 15 to 40% by weight.

18. The component according to claim 17, wherein the thermoplastic styrene (co)polymer A1 also comprises a proportion of from 0 to 70% by weight, based on the weight of the styrene (co)polymer A1, of α-methylstyrene or n-phenylmaleimide.

19. The component according to claim 16, wherein the thermoplastic polyester A2 has been selected from the group consisting of polyethylene terephthalate, polytrimethylene terephthalate, polybutylene terephthalate, and copolyesters composed of one or more diacids with one or more diols and optionally with one or more lactones.

20. The component according to claim 16, wherein at least one of the thermoplastic polyesters A2 of the first plastics component A has a lower melting point than the polyester B1 of the second plastics component B, or has a glass transition temperature lower than the melting point of the polyester B1 of the second plastics component.

21. The component according to claim 16, wherein the semicrystalline, thermoplastic polyester B1 of the second plastics component B is a polyalkylene terephthalate or a mixture composed of at least two different polyalkylene terephthalates.

22. The component according to claim 21, wherein the polyalkylene terephthalate has from 2 to 10 carbon atoms in the alcohol moiety.

23. The component according to claim 21, wherein the polyalkylene terephthalate is a polyethylene terephthalate, polytrimethylene terephthalate, polypropylene terephthalate, polybutylene terephthalate, or a mixture composed of at least two of these polyalkylene terephthalates.

24. The component according to claim 16, wherein the thermoplastic styrene (co)polymer B2 has been selected from the group consisting of acrylonitrile-styrene-acrylate, acrylonitrile-butadiene-styrene copolymers, styrene-acrylonitrile copolymers, and mixtures thereof.

25. The component according to claim 16, wherein the first plastics component A and/or the second plastics component B also comprises one or more additives, selected from the group consisting of fibrous fillers, particulate fillers, impact modifiers, flame retardants, nucleating agents, carbon black, pigments, colorants, mold-release agents, heat-aging stabilizers, antioxidants, processing stabilizers, and compatibilizers.

26. The component according to claim 16, wherein the first plastics component A comprises from 0.1 to 40% by weight of glass beads, based on the total weight of the first plastics component A.

27. The component according to claim 16, wherein the second plastics component B comprises from 0.1 to 50% by weight of fibrous fillers, based on the total weight of the second plastics component B.

28. The component according to claim 27, wherein the fibrous fillers are glass fibers.

29. The component according to claim 16, wherein the insert part has been manufactured from copper, from a copper-containing alloy, from aluminum, from an aluminum-containing alloy, from titanium, from stainless steel, from a lead-free metal, or from a metal alloy, or from any material with tin coating.

30. The component according to claim 16, wherein the component is a plastics part as used in electronic engineering, a mechatronic component, or a plastics casing with plug-in contacts.

31. A process for the production of the component according to claim 16, comprising the following steps:
(a) sheathing of an insert part with a first plastics component A, where the first plastics component A is composed of:
A1: from 50 to 100% by weight of at least one thermoplastic styrene (co)polymer and
A2: from 0 to 50% by weight of at least one thermoplastic (co)polyester,
in each case based on the polymer content of the first plastics component A,
(b) molding of exterior sheathing composed of a second plastics component B, where the second plastics component B is composed of:
B1: from 50 to 100% by weight of at least one semicrystalline, thermoplastic polyester based on aromatic dicarboxylic acids and on aliphatic or aromatic dihydroxy compounds and
B2: from 0 to 50% by weight of at least one thermoplastic styrene (co)polymer,
in each case based on the polymer content of the second plastics component B,
where either the insert part is first sheathed with the first plastics component A and then the second plastics component B is applied or the exterior sheathing B is first molded, and then the first plastics component A is charged to a cavity between the exterior sheathing composed of the second plastics component B and the insert part, in order to form the sheathing of the insert part.

32. The process according to claim 31, wherein the sheathing of the insert part with the first plastics component A and the sheathing composed of the second plastics component B are produced via an injection-molding process.
